(19) United States
(12) Patent Application Publication
(10) Pub. No.: US 2008/0266204 A1
(43) Pub. Date: Oct. 30, 2008

(54) Method, Device and System for Creating Images, Text and Information that are Visible Under Incident Light

(76) Inventors: Frank Bartels, Dortmund (DE); Nader Mark Isam Tahhan, Stegen (DE); Dieter Jerosch, Bad Soden (DE); Oliver Muller-Marc, Appenzell (CH)

Correspondence Address: Takeuchi & Kubotera, 200 Daingerfield Rd, Suite 202, Alexandria, VA, 22314, US

(21) Appl. No.: 11/793,421

(22) PCT Filed: Dec. 20, 2005
(86) PCT No.: PCT/EP05/13741

§ 371 Date: Apr. 10, 2008

(30) Foreign Application Priority Data
Dec. 20, 2004 (DE) 10 2004 062 650.2

(51) Int. Cl. G09G 5/00

(52) U.S. Cl. 345/1.1

(57) ABSTRACT

System (1) is provided for the creation of images, texts and information that are visible under incident light. The system (1) includes: at least one display (10); and one control unit (11) for the control of the display (10). The control unit (11) is connected with a display (10), and/or at least one sensor (13), and/or at least one second remote control unit (12) via at least one interface (110).

The present invention relates to a method, device and system for creating images, text and information that are visible under incident light.

For instance from the EP 1090384 B1 and the U.S. Pat. No. 6,747,777 B1 an apparatus for the production of images, texts and information is known, through which reflected light produces recognisable and quickly alternating black and white or coloured images. Such apparata are particularly useful for the display during daylight and/or artificial light in house or outdoors. Consequently, such apparata are particularly useful to display information and/or pictures of all kinds.

As a consequence the object of the present invention is to provide a method, device and system for creating images, text and information that are visible under incident light and that are capable of providing an optimal use and application of the above mentioned apparatus of the prior art.

The object of the present invention is solved with the features of the claims. Preferred embodiments and preferred features of the invention are mentioned without any limitation in the following description which is accompanied by schematic drawings.

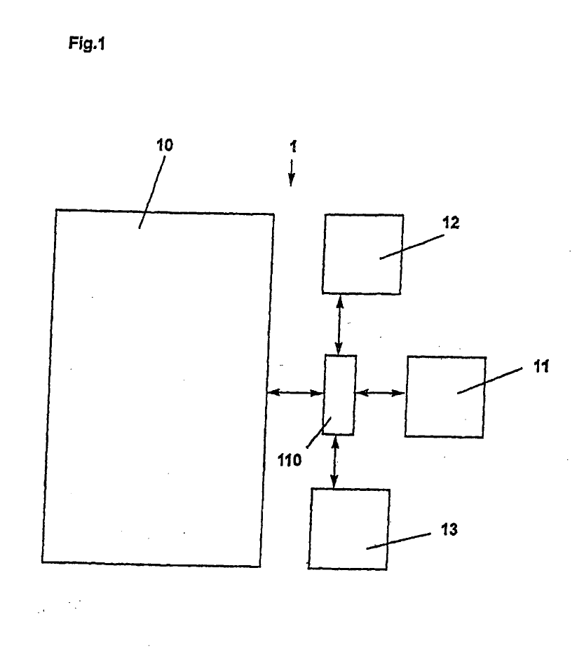

FIG. 1 shows a schematic representation of a system 1 according to the present invention for the creation of images, texts and information that are visible under incident light, together with their essential elements.

According to the invention there is provided a system for the creation of images, texts and information that are visible under incident light, which is characterised in that known apparatus for the display of information and/or text and/or graphics and/or pictures can be replaced through the above mentioned device for the creation of images, texts and information, whereby there is particularly provided a possible optimal and maximal optimised display of information. In the context of the present application, the display of information is understood such that the information naturally can comprise text, images, symbols, colours, graphics and sequences of images. The system for the creation of images, text and information that are visible under incident light further comprises features which are particularly used in order to replace known apparatus for the display of information of any kind such as particularly traffic signs, signs, posters, displays and particularly for advertisement as well as indoor and outdoor arrangements of any kind. In context of the present invention, display is understood as a display of any type, dimension or use of any information.

Said system comprises at least one display panel, a control unit for controlling the display panel, the unit being connected to at least one display panel and/or at least one sensor and/or at least one second remote-control unit via at least one interface. According to the present invention, the system comprises particularly and preferably a plurality of interfaces, whereby the control unit is preferably connected with a plurality of displays and/or a plurality of sensors and/or a plurality of second remote control units.

In particular, the present invention further comprises a method for the operation of the system for creating images, text and information and information that are visible under incident light, whereby said system comprises an identification and recognition and conformation, feedback and response system which operates with at least one sensor and whereby the information that is displayed on the display and/or the frequency of alternating information is depending on signals of the sensors.

The term sensor in the sense of the present application has a global and broad meaning and comprises devices for the detection of signals and/or transmission and/or identification and/or registration of information of any kind, in particular such as receivers for electromagnetic waves, optical sensors, temperature sensors, etc. The present invention will now be described in detail with reference to the accompanying drawings.

FIG. 1 shows a schematic view of a system 1 for the creation of images, texts and information and information that are visible under incident light which is directed to the display and which comprises at least a display 10 together with a control unit 11 for the control of the display 10, whereby the control unit 11 is connected with the display 10 via at least one interface 110 and/or is connected with at least one sensor 13 and/or with at least one second remote control unit 12. Preferably the control unit 11 can be connected and can operate together with a plurality of display units 10 and/or a plurality of sensors 13 and or a plurality of second remote control units 12 via a plurality of interfaces. The control unit 11 and the second remote control unit 12 preferably comprise an electronic computer and the interfaces 110 preferably comprise an interface 110 for the cabled and/or wireless data-transmission and communication and/or information-transmission. The sensors 13 preferably comprise at least one electrical and/or optical and/or acoustic and/or thermal and/or electromagnetic sensor and/or a GPS-unit for the detection of information of any kind. The interfaces 110 preferably comprise at least a RS232 and/or USB and/or LAN and/or Bluetooth and/or DECT and/or WLAN-interface and/or a modem for the transmission of data via the GSM and/or UMTS frequency range.

The above mentioned interfaces 110 particularly allow to preferably control the display 10 in versatile and flexible ways, whereby the system 1 can be designed to exchange information via the internet and/or via mobile phone networks. The sensors 13 can particularly comprise sensors for the detection of time and date and/or weather and/or temperature and/or daylight and/or the number and/or quantity and/or identity and/or frequency and/or distance of the observer, user or consumer of the display 10 and/or the location and/or the operating status of the display 10. The information which is displayed on the display 10 of the system 1 according to the present invention can particularly be provided by means of an electronic computer via electronic signals whereby the computer may communicate with at least one remote-computer 12 and/or may completely and/or partially be controlled by the remote computer 12.

The above mentioned system 1 according to the present invention can be preferably used to display the information which is shown on display 10 and/or the frequency of alternating information in dependence of internal or external events, whereby the events are provided as a signal via the interfaces 110 and the control unit 11. Together with the system 1 of the present invention for the creation of images, text and information that are (readable and) visible under incident light which is directed to a display, there is further provided a method for the operation of the system 1 according to the present invention which comprises a system for the detection identification and recognition and conformation, feedback and response with at least one sensor 13 and first 11 and/or the second 12 control unit, whereby the content shown on the display 10 and/or the frequency of alternating contents depends on the signals of the sensors 13.

The display 10 according to the present invention can be preferably provided with an electronic display 10 which comprises a plurality of pixels which are controlled by microfluidic system.

Subsequently and particularly some preferred applications and uses of the system 1 and the method for the operation of the system 1 and the detection, identification and recognition and conformation, feedback and response system according to the present invention are described.

The display 10, particularly and preferably, can be represented by a large advertisement display such as a poster, whereby people close to the poster can be particularly detected via their mobile phones or optically detected, whereby the number, the time, the stay and the identity (such as female, male, age, nationality) of the persons is detected and whereby the detected data are preferably and particularly used for the control of the information, which is shown on the display 10. It is also clear that the detected data can be used for statistical information only.

The detection, identification and recognition and conformation and feedback and response system according to the present invention can preferably be used to provide the display of contents on the display 10 according to, and depending on, a specific target audience, whereby the target audience can be particularly identified via mobile phone or particularly identified via a selection of chip codes of the individual person or of the audience, that has been particularly described above. However, a sensor 13 can also particularly comprise of a wireless receiver, such as a mobile phone, with the consequence that the consumer is capable of actively manipulating and/or selecting and/or controlling the information which is shown on the display 10. This can be particularly realised via the transmission of an SMS to a sensor 13.

For example, and in particular, touch sensors can be arranged at the display 10, whereby, via the touchsensors, a control of the information which is shown on the display 10 can be conducted. A sensor 13 can by way of example and in particular comprise a camera which particularly captures the display 10 and/or the environment of the display 10 and which displays by way of example a person of the audience of the display 10 also on the display 10.

As mentioned above, the term information in the context of the present application is used in a very broad sense and comprises information of any kind particularly including news and/or advertisement and/or entertainment.

The system 1, the method of operating the system 1 and the detection, identification and recognition and conformation, feedback and response system according to the present invention is, for instance, particularly capable of providing advertisement, which is maximally targeted to a specific audience, particularly for an automobile on the display 10 whereby the displayed model can be varied depending on the identification of the viewer (female, male, age, nationality, etc.). Moreover, the viewer can by way of example, preferably choose partial views which can be enlarged and/or shown in exploded views and/or particularly the viewer can amend the perspective of the display and/or view the shown model together with the self image.

A system 1, according to the present invention, can particularly comprise of a wireless receiver and also a wireless sender, (such as a mobile phone receiver and mobile phone transmitter), and can particularly notify information on the operating status of the system 1 via SMS to a remote control unit. The information on the operating status of the system 1 and the display 10 can comprise information on the technical operating status, the present shown contents, information on the location and information on the audience, whereby the remote control unit controls the contents that are shown on the display 10 in dependence of the above mentioned information.

By way of example, the display 10 can preferably be used transportably on a vehicle depending on the location of the vehicle, which van be detected via GPS. Accordingly, such information which is shown on the display 10 can be changed and varied.

By way of example, the information shown on the display 10 can be varied depending on the location of the viewer. Preferably, and by way of example, a headline can be shown to a remote viewer. When the viewer approaches the display 10 it is possible to display detailed information on the display 10 which corresponds to the above mentioned headline.

According to the invention, the display 10 can particularly be used to display information which can be accessed vie the internet, whereby the access of the information of the viewer or user can be carried on particularly by touch sensors or wireless control units such as mobile phones.

The detection, identification and recognition and conformation, feedback and response system according to the present invention which has been described above and which can preferably be designed to operate dynamically and/or interactively is particularly and preferably capable of versatilely amending and varying the information shown by the display 10 depending on the signals of the sensors 13 and a dynamic and/or interactive amendment or variation according to the present invention can comprise of the selection, display, frequency and kind of displayed information, such as altitude, colour, language, contents, rotation of text, image and symbols.

By way of example, the identity of the viewer, which is detected by the means of the sensor 10, can be used for greetings and regards together with the name of the viewer on the display 10. Moreover it is possible that a user is allowed to display text and/or images on the display 10 by means of his mobile telephone.

According to the invention, the display 10 can preferably be used as a pin board or an electronic pin board for the exchange of news or for advertisement particularly in department stores, trade fairs, railway stations, airports, etc. In particular, a control unit of the display 10 can also comprise of a debit collection system which collects fees for the control of the display 10 by the user via wireless transmission and in particular via mobile telephone systems, whereby the fees can be particularly collected for the system 1 and the display 10 for advertisement purposes of the viewer.

1. System (1) for the creation of images, texts and information that are visible under incident light, whereby the system (1) comprises:
at least one display (10); and
one control unit (11) for the control of the display (10);
wherein the control unit (11) is connected with the display (10), and/or at least one sensor (13), and/or at least one second remote control unit (12) via at least one interface (110).

2. System (1) according to claim 1, whereby: the control unit (11) is connected with a plurality of displays (10) and/or a plurality of sensors (13) and/or a plurality of second remote control units (12) via a plurality of interfaces (110).

3. System (1) according to claim 1 whereby: the control unit (11) comprises an electronic computer; the second remote control unit (12) comprises an electronic computer; and the interfaces (110) comprise at least one interface (110) for cabled and/or wireless data transmission and/or communication.

4. System (1) according to claim 1, whereby: the sensors (13) comprise of at least one electrical, and/or optical, and/or acoustical, and/or thermal, and/or electromagnetic sensor (13), and/or a GPS-unit.

5. System (1) according to claim 1, whereby: the interfaces (110) comprise of at least one RS232, and/or USB, and/or LAN, and/or Blue Tooth, and/or DECT, and/or WLAN-Interface, and/or a modem for transmission of data in the frequency range of GSM, and/or GPRS, and/or UMTS.

6. Method for the operation of the system (1) according to claim 1, whereby: said system (1) comprises a detection, identification and recognition and conformation, feedback and response system comprising at least one sensor (13) and said first (11) and/or second (12) control unit, whereby the contents and/or the frequency of alternating contents which are shown on the display (10) depend on the signals of the sensors (13).

7. Method according to claim 6, whereby: said signals of said sensors (13) comprise of information on time and date, and Y/or weather, and/or temperature, and/or daylight, and/or number, and/or identity, and/or frequency, and/or distance of the audience of the display (10), and/or the location, and/or the operating status of the display (10).

8. Device for the display (10) of the system (1) according to claim 1, whereby: the device comprises an electronic display with a plurality of pixels which are controlled via a microfluidic system.

9. Use of the system (1) according to claim 1 as a dynamic and/or interactive display of information.

10. Use according to claim 9 for the display of information and/or for advertisement purposes and/or news and/or for entertainment.

11. Use of according to claim 9, whereby the use comprises of a debt collection system, which collects fees for the interactive use.
